(19) United States
(12) Patent Application Publication
(10) Pub. No.: US 2026/0117394 A1
(43) Pub. Date: Apr. 30, 2026

(54) SELF HEALING PLASMA ELECTROYTIC OXIDATION COATING

(71) Applicant: Hamilton Sundstrand Corporation, Charlotte, NC (US)

(72) Inventor: Jithin Kuttiyadan, Bangalore (IN)

(21) Appl. No.: 19/371,093

(22) Filed: Oct. 28, 2025

(30) Foreign Application Priority Data
Oct. 28, 2024 (IN) 202411082398

(51) Int. Cl. C23F 11/14; C09D 1/00; C09D 5/08; C09D 7/40; C09D 7/63

(52) U.S. Cl. CPC C23F 11/149; C09D 1/00; C09D 5/086; C09D 7/63; C09D 7/70

(57) ABSTRACT

An aircraft component including an aluminum substrate and a plasma electrolytic oxidation (PEO) coating disposed on the aluminum substrate. The PEO coating includes a plurality of cavities. A set of nano capsules disposed in the plurality of cavities, with at least a portion of the nano capsules in the set of nano capsules containing a corrosion inhibitor.

### CROSS REFERENCE TO RELATED APPLICATIONS

This application claims the benefit of Indian Provisional Patent Application No. 202411082398 filed Oct. 28, 2024, the disclosure of which is incorporated herein by reference in its entirety.

### BACKGROUND

Exemplary embodiments pertain to the art of plasma electrolytic oxidation (PEO) coatings, and more particularly to a PEO coating including self healing inhibitors.

Precipitation hardened high strength aluminum alloys, such as AL7075, play an important role in increasing fuel economy, speed and payload capacity of aircraft structures. However, corrosion behavior is influenced by the precipitates present and the hardened aluminum can be prone to pitting, intergranular corrosion, stress corrosion, cracking, and exfoliation corrosion.

To address the susceptibility to corrosion, some components incorporate a chromic-acid anodization coating. Chromic-acid anodization coatings provide some degree of protection, however the protection provided is not always ideal and application of the chromic-acid anodization coating can involve hazardous materials. Due to the nature of chromic-acid anodization coatings, the coatings include some self healing properties.

Existing replacement coating systems have not been able to remove the negative properties of the chromic-acid anodization coatings (e.g., the use of hazardous materials) while still maintaining the self-healing benefits of a chromic-acid anodization coating.

### BRIEF DESCRIPTION

Disclosed is an aircraft component including an aluminum substrate and a plasma electrolytic oxidation (PEO) coating disposed on the aluminum substrate. The PEO coating includes a plurality of cavities. A set of nano capsules disposed in the plurality of cavities, with at least a portion of the nano capsules in the set of nano capsules containing a corrosion inhibitor.

In some further examples, the nano capsules are mesoporous silica nano capsules (MSN).

In some further examples, the corrosion inhibitor is an organic corrosion inhibitor.

In some further examples, the organic corrosion inhibitor is one of Salicylaldoxime, 8-hydroxyquinoline, and Quinaldic acid.

In some further examples, all nano capsules in the set of nano capsules contain the corrosion inhibitor.

In some further examples, the aluminum substrate is one of an Al 2 alloy and an Al 6 alloy.

In some further examples, the aluminum substrate is an Al7075 alloy.

In some further examples, an outer shell of each nano capsule breaks down in response to exposure to corrosion having pH levels above a threshold pH level.

In some further examples, each nano capsule includes a shell and wherein each shell includes an inserted polyelectrolyte material.

Also disclosed is a method for self healing an aircraft component surface. The method includes responding to exposure to a corrosive environment by releasing a corrosion inhibitor from a nano capsule. The nano capsule is disposed in a cavity of a plasma electrolytic oxidation (PEO) coating. The method allows the corrosion inhibitor to coat the PEO coating, thereby preventing corrosion of an aluminum substrate on which the PEO coating is deposited.

In some further examples, releasing the corrosion inhibitor from the nano capsule comprises allowing a wall of the nano capsule to break down when exposed to a pH level above a threshold pH level.

In some further examples, the nano capsules are mesoporous silica nano capsules (MSN).

In some further examples, the corrosion inhibitor is an organic corrosion inhibitor.

In some further examples, the organic corrosion inhibitor is one of Salicylaldoxime, 8-hydroxyquinoline, and Quinaldic acid.

In some further examples, the aluminum substrate is one of an Al 2 alloy and an Al 6 alloy.

In some further examples, the aluminum substrate is an Al7075 alloy.

In some further examples, each nano capsule includes a shell and wherein each shell includes an inserted polyelectrolyte material.

Also disclosed is a method for creating a self-healing aluminum surface for an aircraft component. The method includes impregnating nano capsules with a corrosion inhibitor, depositing a plasma electrolytic oxidation (PEO) coating on an aluminum substrate, and depositing the nano capsules in pores of the PEO coating.

In some further examples, the method further includes configuring the nano capsules such that an exterior wall of the nano capsules breaks down in response to exposure to a pH level above a threshold, thereby releasing the corrosion inhibitor.

In some further examples, the corrosion inhibitor is an organic corrosion inhibitor.

### BRIEF DESCRIPTION OF THE DRAWINGS

The following descriptions should not be considered limiting in any way. With reference to the accompanying drawings, like elements are numbered alike:

FIG. 1 is a material including a substrate and a self healing plasma electrolytic oxidation (PEO) coating;

FIG. 2 is a silica nano capsule for use in the self healing PEO coating of FIG. 1;

FIG. 3 is an exemplary process for applying the self healing PEO coating of FIG. 1; and

FIG. 4 is a self healing process of the self healing PEO coating of FIG. 1.

### DETAILED DESCRIPTION

A detailed description of one or more embodiments of the disclosed apparatus and method are presented herein by way of exemplification and not limitation with reference to the Figures.

Aluminum alloys offer advantageous properties for certain components, including aircraft components. However, the limited corrosion resistance of aluminum alloys presents a significant challenge in aerospace applications. Corrosion of aircraft aluminum alloys profoundly affects the longevity and performance of aircraft components, making corrosion an important issue beyond just surface-level concerns. Material loss due to corrosion can have a negative impact on the loadbearing capacity of aerospace components. Therefore, appropriate surface modification treatments are used to achieve corrosion protection.

One advanced anodization technique, referred to as Plasma Electrolytic Oxidation (PEO), provides an effective strategy to enhance the surface characteristics of aircraft aluminum alloy components. As is appreciated in the art, PEO coatings interact differently with different substrate materials, and processes and techniques that function successfully on one substrate material may not necessarily function as well, or at all, on a different substrate material.

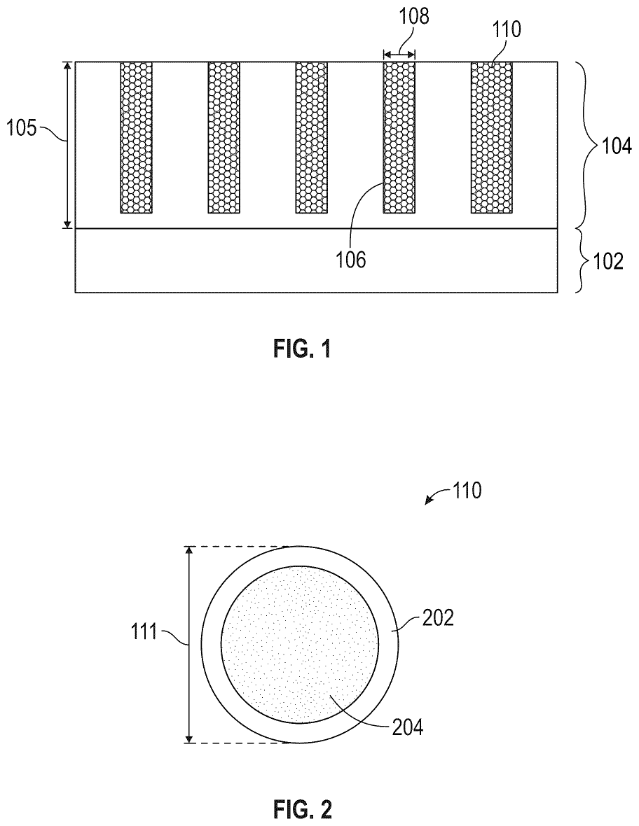

FIG. 1 illustrates an example aluminum substrate 102 with a PEO coating 104 applied thereon. The example of FIG. 1 is schematic in nature and is not drawn to scale. Certain features are exaggerated in size and/or frequency for the sake of illustration. The PEO coating 104 includes porous cavities 106 that are evenly distributed about the PEO coating 104. As used herein “evenly distributed” refers to a distribution of approximately even density and does not refer to an exactly uniform distribution. The porous cavities do not extend a full depth 105 of the PEO coating 104.

FIG. 2 illustrates a cross section of a nano capsule 110, which are contained within the porous cavities 106 of the PEO coating 104. Contained within walls 202 of each nano capsule 110 is a corrosion inhibitor 204.

PEO coating methods operate by generating plasma near a coating. The plasma modifies the coating structure and stabilizes high temperature aluminum phases at room temperature creating the PEO coating. In one example, the high temperature involved in the process stabilizes alumina phases, such as α-Al2O3, the hardest alumina phase.

In addition, as the cavities 106 have a diameter 108 larger a diameter 111 of a set of nano capsules 110 the PEO coating 104 incorporate inhibitor-loaded containers (nano capsules 110) into the structure of the coating 104. This stabilization of α-Al2O3 and incorporation of corrosion inhibitor improves the coated layer's tribological properties and corrosion resistance. While described with particular reference to α-Al2O3, it is appreciated that the structures and processes described herein could be beneficially extended to any aluminum substrate, and particularly to any Al2 or Al6 series aluminum substrate.

Plasma electrolytic oxidation (PEO) allows the fabrication of ceramic oxide layer coatings on light metals (such as aluminum) for enhancing the corrosion and wear resistance of the metal. The PEO process is usually carried out at high potential, the coating formation and the growth is assisted by the di-electric breakdown phenomenon. The substrate converting PEO process produces a highly adhesive oxide layer.

While the anticorrosion PEO coatings alone provide a barrier between the metal and a corrosive environment, further enhancement in corrosion protection is achieved by doping nanocontainers 110 impregnated with corrosion inhibitor 204 into the PEO coating 104. The PEO coating 104 including the nano capsules 110 containing the corrosion inhibitor 204 not only provides the barrier of the PEO coating, but also releases the corrosion inhibitor 204 continually to a damaged location for a duration of corrosion exposure, thereby limiting or eliminating the impact of corrosion on the underlying substrate material. In some examples, every nano capsule 110 includes the corrosion inhibitor 204. In other examples, a subset of the nano capsules 110 include the corrosion inhibitor, while a second subset of the nano capsules 110 include alternative fluids that may provide additional benefits when subjected to corrosion.

In one example, the nano capsules 110 are mesoporous silica nano capsules (MSN). MSN capsules are particularly beneficial as corrosion inhibitor delivery mechanisms due to their high stability, compatibility, large specific surface area, governable pore diameter, and easy surface functionalization. The higher corrosion resistance of the PEO coating incorporating the MSN nano capsules 110 into the PEO coating 104 is attributable to release of corrosion inhibitors from the MSN capsules 110 due to corrosion attacking at the interface of the MSN capsule 110. An inhibitor loaded MSN capsule 110 provides an immediate release response to corrosion by breaking down and allowing the contained inhibitor to be released. Due to the variation of pH value at a corroded area, the MSN capsules 110 release maximum inhibitors within few minutes of the corrosion occurring, and with a higher concentration at the location of the corrosion.

In one example, the material forming the MSN capsules 110 includes insertion of a polyelectrolyte, and the insertion of the polyelectrolytic material reduces the release rate of the inhibitor 204 and increases a time and efficiency of the inhibitor 204.

The MSN capsules 110 are, in one example, sealed with a thin polymeric organic phase material leading to the formation of hybrid material for the wall 202. The hybrid material combines the characteristics of both materials (e.g., a hybrid silican/chitosan material). The hybrid materials are fully characterized at the molecular, mesoscopic and nanometric length scales and the can be applied in pH-sensitive smart coatings as to provide the corrosion inhibition.

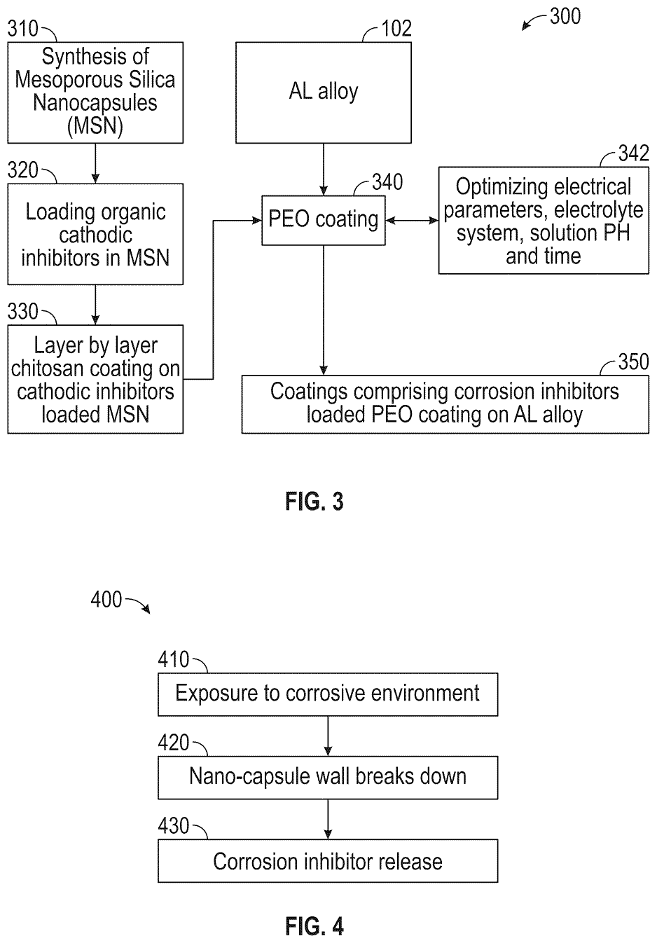

With continued reference to FIGS. 1 and 2, FIG. 3 illustrates an example process 300 for generating the material structure illustrated and FIG. 1.

Initially the process synthesizes MSN capsules in a synthesis step 310. In one example of step 310, the MSN nano capsules are synthesized by mixing 150 ml ethanol with 255 ml of distilled deionized water. 5 ml of tetraethyl orthosilicate (TEOS) is gradually added to this solution. After stirring for 10 min, 0.8 g of cetyl trimethyl ammonium bromide (CTAB) is added to the mixture. Then, 5 ml of NH4OH is added into the resultant solution and stirred for 3 hours at room temperature. Finally, silica nano capsules are collected by centrifugation at 10000 RPM for 20 min.

A corrosion inhibitor is loaded into the synthesized nano capsules 110 in a load capsules step 320. In one example, the corrosion inhibitor is an organic corrosion inhibitor, such as Salicylaldoxime, 8-hydroxyquinoline, or Quinaldic acid. In alternative examples, similar corrosion inhibitors may be used in the same capacity. Organic corrosion inhibitors can be otherwise referred to as green inhibitors. To load the corrosion inhibitor into the synthesized MSN capsules 110, in one example, the MSN capsules are added to an ethanolic inhibitor solution (20 mg/l) and stirred for 36 hrs. Then, inhibitor loaded MSN are collected by centrifugation, washed with deionized water and dried overnight at 60° C.

Parallel to steps 310 and 320 a PEO coating 104 is applied to an aluminum alloy substrate 102 in a PEO coating step 340.

The MSN capsules 110 are provided in an aqueous solution, such as a chitosan solution, and multiple layers of the aqueous solution including the loaded MSN nano capsules are applied to the PEO coating 104 in a multi-layer process at an apply MSN nano capsules step 330. In one example, a chitosan aqueous solution is prepared by adding the 0.5 wt % chitosan in acetic acid with pH 5.0. Then, the inhibitor loaded MSN capsules 110 are added to the chitosan solution. The solution is then stirred for 24 hours, after which the solution is centrifuged. The resultant precipitate is washed with water and dried under vacuum.

Once sufficient layers are applied, a coating including corrosion inhibitors is considered fully applied, and the process 300 is complete in final step 350.

In some examples, the deposition of the oxide forming the PEO layer can be optimized using an optimizing process 342. Prior to the PEO treatment, aluminum samples of suitable size are polished up to 1200 grit SiC emery paper, de-greased with acetone and ultrasonically cleaned in double distilled water. In one example PEO process an electrical potential of 100-800 V was applied, providing a current density of 0.1 to 1 A/cm2 at the workpiece. The aluminum alloy workpiece to be coated is set as the anode and the electrolyte containing steel container acts as a cathode. Empirical experiments can be conducted by various electrolyte systems including alkaline silicate and phosphate solutions at different process parameters. The empirical experiments identify the appropriate parameters to obtain a thick, dense and adherent oxide layer of optimized property. The resultant optimal process can be applied to create the PEO coating at step 340 for the aluminum substrate of the actual component.

With continued reference to FIGS. 1-3, FIG. 4 illustrates an exemplary process 400 by which the self healing PEO coating 104 of FIG. 1 self heals when exposed to corrosion. At an initial step 410, the component constructed of the aluminum alloy 102 with the PEO coating 104 is exposed to a corrosive environment in an “Exposure to Corrosive Environment” step 410. As used herein a “corrosive environment” is any environment having a pH level above which a silica structure defining the walls 202 of the silica nano capsules 110 begins to break down.

Once exposed, the walls 202 corrode and break down in a “Nano-Capsule Walls Break Down” step 420. As the walls break down the interior of the nano-capsule 110 is exposed and a corrosion inhibitor 204 escapes the nano-capsule in a “Corrosion Inhibitor Release” step 430. The release of the corrosion inhibitor causes the corrosion inhibitor to coat the portions of the PEO coating that are exposed to the corrosive environment and inhibits further corrosion. The prevention of further corrosion is referred to as the self-healing and increases a useable lifespan of the component including the PEO coated aluminum.

The PEO coating is able to continue self-healing as long as the cavities 106 include silica nano capsules 110. Furthermore, in some examples, a component including the PEO coated aluminum may have additional silica nano capsules applied after a self-healing incident. Re-applying the silica nano capsules 110 further increases the lifespan of the component by refreshing the self-healing ability of the PEO coating.

While described generally above with regards to aluminum aircraft components, one component type that will see particular benefit from the self-healing PEO coating described herein is an aluminum cylinder used in aircraft actuation. Such components are typically exposed to harsh environments and replacing existing protections and coatings with the PEO coating described herein can prolong the life of the component, as well as minimize the use of hazardous chemicals in the creation of the coating. Similarly, landing gear components are repeatedly exposed to harsh environments, and will benefit in the same manner.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An aircraft component comprising:
an aluminum substrate;
a plasma electrolytic oxidation (PEO) coating disposed on the aluminum substrate, the PEO coating comprising a plurality of cavities; and
a set of nano capsules disposed in the plurality of cavities, at least a portion of the nano capsules in the set of nano capsules containing a corrosion inhibitor.

2. The aircraft component of claim 1, wherein the nano capsules are mesoporous silica nano capsules (MSN).

3. The aircraft component of claim 1, wherein the corrosion inhibitor is an organic corrosion inhibitor.

4. The aircraft component of claim 1, wherein the organic corrosion inhibitor is one of Salicylaldoxime, 8-hydroxyquinoline, and Quinaldic acid.

5. The aircraft component of claim 1, wherein all nano capsules in the set of nano capsules contain the corrosion inhibitor.

6. The aircraft component of claim 1, wherein the aluminum substrate is one of an Al 2 alloy and an Al 6 alloy.

7. The aircraft component of claim 1, wherein the aluminum substrate is an Al7075 alloy.

8. The aircraft component of claim 1, wherein an outer shell of each nano capsule breaks down in response to exposure to corrosion having pH levels above a threshold pH level.

9. The aircraft component of claim 1, wherein each nano capsule includes a shell and wherein each shell includes an inserted polyelectrolyte material.

10. A method for self healing an aircraft component surface comprising:
responding to exposure to a corrosive environment by releasing a corrosion inhibitor from a nano capsule, wherein the nano capsule is disposed in a cavity of a plasma electrolytic oxidation (PEO) coating; and
allowing the corrosion inhibitor to coat the PEO coating, thereby preventing corrosion of an aluminum substrate on which the PEO coating is deposited.

11. The method of claim 10, wherein releasing the corrosion inhibitor from the nano capsule comprises allowing a wall of the nano capsule to break down when exposed to a pH level above a threshold pH level.

12. The method of claim 10, wherein the nano capsules are mesoporous silica nano capsules (MSN).

13. The method of claim 10, wherein the corrosion inhibitor is an organic corrosion inhibitor.

14. The method of claim 10, wherein the organic corrosion inhibitor is one of Salicylaldoxime, 8-hydroxyquinoline, and Quinaldic acid.

15. The method of claim 10, wherein the aluminum substrate is one of an Al 2 alloy and an Al 6 alloy.

16. The method of claim 10, wherein the aluminum substrate is an Al7075 alloy.

17. The method of claim 10, wherein each nano capsule includes a shell and wherein each shell includes an inserted polyelectrolyte material.

18. A method for creating a self-healing aluminum surface for an aircraft component, the method comprising:
impregnating nano capsules with a corrosion inhibitor;
depositing a plasma electrolytic oxidation (PEO) coating on an aluminum substrate; and
depositing the nano capsules in pores of the PEO coating.

19. The method of claim 18, further comprising configuring the nano capsules such that an exterior wall of the nano capsules breaks down in response to exposure to a pH level above a threshold, thereby releasing the corrosion inhibitor.

20. The method of claim 18, wherein the corrosion inhibitor is an organic corrosion inhibitor.
